(19) United States
(12) Patent Application Publication
(10) Pub. No.: US 2019/0353225 A1
(43) Pub. Date: Nov. 21, 2019

(54) SEAL CHAIN

(71) Applicant: TSUBAKIMOTO CHAIN CO., Osaka-shi, Osaka (JP)

(72) Inventors: Takuya Yasu, Osaka-shi (JP); Yusuke Nishizawa, Osaka-shi (JP)

(73) Assignee: TSUBAKIMOTO CHAIN CO., Osaka-shi, Osaka (JP)

(21) Appl. No.: 16/482,826

(22) PCT Filed: Dec. 20, 2017
(86) PCT No.: PCT/JP2017/045794

§ 371 Date: Aug. 1, 2019

(30) Foreign Application Priority Data
Feb. 7, 2017 (JP) 2017-020505

(51) Int. Cl. F16G 13/06

(52) U.S. Cl. CPC F16G 13/06; F16G 15/12

(57) ABSTRACT

The seal chain comprises two inner link plates, a bushing, a pin inserted into the bushing, a roller into which the bushing is inserted, two outer link plates, a recess, and a seal. Opposite ends of the bushing are respectively joined to the two inner link plates. The roller is supported by the bushing. The two outer link plates are arranged to externally hold the two inner link plates. Opposite ends of the pin are respectively joined to the two outer link plates. The recess is formed in an inner surface of each of the inner link plates to surround the bushing. The seal is arranged between a bottom surface of the recess and an end surface of the roller so as to be accommodated in the recess, and seals lubricant provided between the bushing and the roller.

### TECHNICAL FIELD

The present invention relates to a seal chain having a sealing structure that restricts lubricant provided between a bushing and a roller from being leaked toward the outside.

### BACKGROUND

Patent Document 1 describes a typical example of such type of a seal chain. In such a seal chain, a circular recess with a bushing centered is formed in the inner surface of an inner link plate. Further, an annular recessed groove with the bushing centered is formed in the bottom surface of the recess. An O-ring made of an elastic body such as rubber is fitted into the recessed groove. The O-ring protrudes by a predetermined length from the recessed groove in a natural state.

The opposite end surfaces of a roller includes annular bosses, which are formed by cutting out the outer circumferential side of the roller. A ring-shaped (washer-shaped) seal plate is loosely fitted to the boss in a rotational manner so as to be accommodated in the recess, which is formed in the inner surface of the inner link plate. When the O-ring contacts and presses the seal plate, the lubricant provided between the bushing and the roller is sealed. In the above-described seal chain, the lubricant provided between the bushing and the roller usually leaks from the distal end surface of the boss of the roller.

### PRIOR ART DOCUMENT

### Patent Document

Patent Document 1: Japanese Laid-Open Patent Publication No. 2005-282813

### SUMMARY OF THE INVENTION

### Problems that the Invention is to Solve

However, in the above-described seal chain, the O-ring and the seal plate that seal the lubricant are located on the radially outer side of the boss of the roller in the recess of the inner surface of the inner link plate. That is, in the recess of the inner surface of the inner link plate, the O-ring and the seal plate are located away from the position located closer to the distal end surface of the boss of the roller where the lubricant provided between the bushing and the roller leaks.

Although this limits wearing of the O-ring and the seal plate due to the contact with a sprocket, there is room for improvement in sealing the lubricant provided between the bushing and the roller.

It is an objective of the present invention to provide a seal chain that effectively seals lubricant provided between a bushing and a roller for a long period of time.

### Means for Solving the Problem

The means for solving the above-described problem and the advantages will now be described.

A seal chain that solves the above-described problem includes two inner link plates opposed to and spaced apart from each other, a tubular bushing, opposite ends of the bushing being respectively joined to the two inner link plates, a pin rotationally inserted into the bushing, a tubular roller into which the bushing is inserted, the roller being rotationally supported by the bushing, two outer link plates arranged to externally hold the two inner link plates, opposite ends of the pin being respectively joined to the two outer link plates, a recess formed in an inner surface of each of the inner link plates to surround the bushing, and a seal arranged between a bottom surface of the recess and an end surface of the roller so as to be accommodated in the recess, the seal sealing lubricant provided between the bushing and the roller.

This structure includes the seal, which seals the lubricant provided between the bushing and the roller. The seal is located between the bottom surface of the recess and the end surface of the roller so as to be accommodated in the recess. This restricts the seal from contacting the sprocket. Further, the seal seals the lubricant at or near the location where the lubricant provided between the bushing and the roller leaks. Thus, since the seal avoids wearing in a short period of time due to the contact with the sprocket, the seal effectively seals the lubricant, which is located between the bushing and the roller, for a long period of time.

In the seal chain, it is preferred that the seal have an annular shape to surround the bushing and that an inner circumferential surface of the seal be in contact with an outer circumferential surface of the bushing.

This structure effectively restricts the lubricant, which is located between the bushing and the roller, from leaking from the section between the inner circumferential surface of the seal and the outer circumferential surface of the bushing.

In the seal chain, it is preferred that the seal include a first layer made of a self-lubricating material, the first layer being in contact with the end surface of the roller, and a second layer made of an elastic foam, the second layer being in plane contact with both the first layer and the bottom surface of the recess.

In this structure, since the first layer is in plane contact with the second layer, as compared to when the second layer is configured by a typical O-ring described in Patent Document 1, the surface pressure that the first layer receives from the second layer is reduced. Accordingly, the contact pressure of the first layer on the roller is reduced as compared to the typical structure (structure described in Patent Document 1). This and the self-lubrication of the first layer effectively reduce the sliding resistance between the roller and the first layer while the roller is rotating. Thus, the prevention of rotation of the roller by the first layer is restricted. This seals the lubricant, which is located between the bushing and the roller, and restricts the prevention of rotation of the roller.

In the seal chain, it is preferred that the second layer include a low-resilience layer having a relatively low resilience and a high-resilience layer having a relatively high resilience and that the low-resilience layer be located between the first layer and the high-resilience layer.

In this structure, for example, when the low-resilience layer has a high resistance to the lubricant and the high-resilience layer has a low resistance to the lubricant, the resilient force of the high-resilience layer increases the ability of the seal to follow the roller while protecting the high-resilience layer from the lubricant by the low-resilience layer.

In the seal chain, it is preferred that the second layer be made of a closed-cell foam.

In this structure, as compared to when the second layer is made of an open-cell foam, the seal has a high resilience.

In the seal chain, it is preferred that a thickness of the inner link plate be greater than a thickness of the outer link plate and a thickness of a portion of the inner link plate where the recess is formed be greater than or equal to the thickness of the outer link plate.

In this structure, the strength of the portion of the inner link plate where the recess is formed is greater than or the same as that of the outer link plate.

In the seal chain, it is preferred that a height of the inner link plate be greater than a height of the outer link plate.

In this structure, even if the thickness of the inner link plate is not increased, a decrease in the strength of the inner link plate caused by the formation of the recess is limited.

### Effect of the Invention

The present invention effectively seals lubricant provided between a bushing and a roller for a long period of time.

### BRIEF DESCRIPTION OF THE DRAWINGS

FIG. 1 is a cutaway plan view partially showing a seal chain according to a first embodiment.

FIG. 2 is an enlarged view showing the main part of FIG. 1.

FIG. 3 is a side view of FIG. 1.

FIG. 4 is an enlarged view showing the main part of FIG. 2.

FIG. 5 is a cutaway plan view showing the main part of a seal chain according to a second embodiment.

FIG. 6 is an enlarged view showing the main part of FIG. 5.

### MODES FOR CARRYING OUT THE INVENTION

### First Embodiment

A seal chain according to a first embodiment will now be described with reference to the drawings.

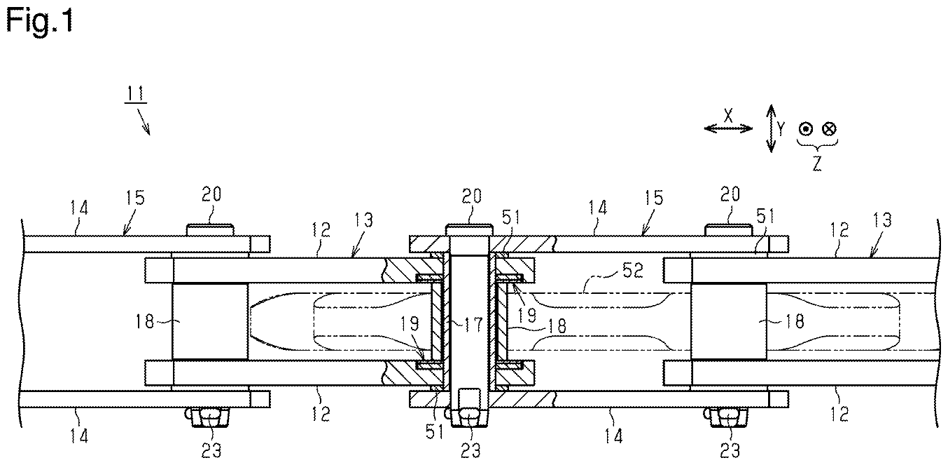

Referring to FIG. 1, a seal chain 11 is made of a steel material and includes inner links 13 and outer links 15. The inner links 13 each include two inner link plates 12 opposed to and spaced apart from each other in a width direction Y. The outer link plates 15 each include two outer link plates 14 arranged to externally hold the two inner link plates 12 in the width direction Y.

The inner link plates 12 of each inner link 13 and the outer link plates 14 of each outer link 15 have a substantially rectangular shape extending in a serial arrangement direction X, which is orthogonal to the width direction Y. The opposite ends of each inner link plate 12 and each outer link plate 14 in the serial arrangement direction X are rounded. The serial arrangement direction X is a movement direction when the seal chain 11 is pulled to move from one side in a longitudinal direction.

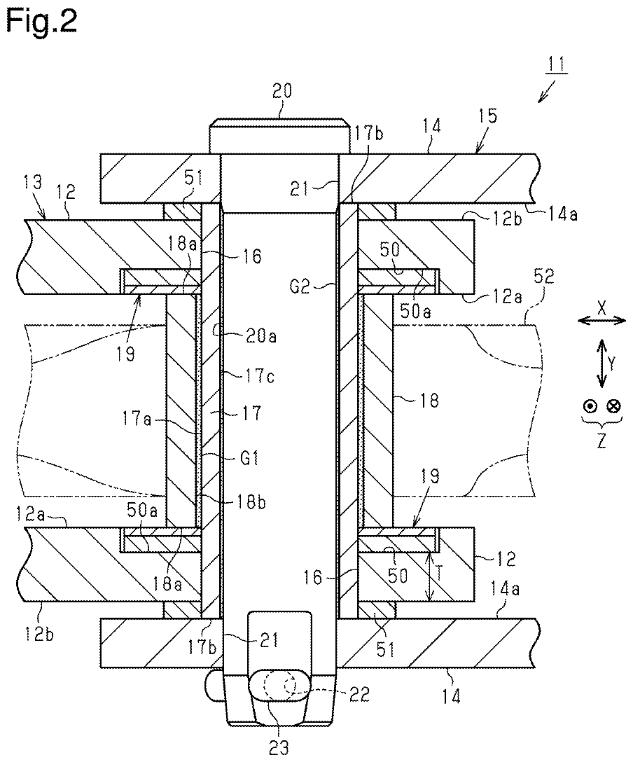

As shown in FIGS. 1 and 2, the opposite ends of each inner link plate 12 in the serial arrangement direction X respectively have circular bushing insertion holes 16 extending through the inner link plate 12 in the width direction Y, which is the thickness direction of the inner link plate 12. Two tubular bushings 17 are installed between the two inner link plates 12, which are opposed to each other in each inner link 13, to maintain the distance between the two inner link plates 12.

The opposite ends of each bushing 17 are respectively fitted (joined) to the bushing insertion holes 16 of the two inner link plates 12 in a non-rotatable manner. The bushing 17 rotationally supports a tubular roller 18 when the bushing 17 is inserted into the roller 18. That is, the roller 18 is loosely fitted to the bushing 17.

Lubricant G1 is provided between an outer circumferential surface 17a of the bushing 17 and an inner circumferential surface 18b of the roller 18. The inner surface 12a of each inner link plate 12 includes an annular recess 50 that surrounds the bushing 17. In each recess 50, a seal 19 is arranged to surround the bushing 17. The seal 19, which has the form of an annular plate, seals the lubricant G1. In this case, the seal 19 is located between a bottom surface 50a of the recess 50 and an end surface 18a of the roller 18 so as to be accommodated in the recess 50. The outer diameters of the recess 50 and the seal 19 are greater than the outer diameter of the roller 18.

The opposite ends of each outer link plate 14 in the serial arrangement direction X respectively have circular pin insertion holes 21. Columnar pins 20, having a slightly smaller outer diameter than the inner diameter of the bushings 17, are inserted and fitted into the pin insertion holes 21. The pin insertion holes 21 extend through the outer link plate 14 in the width direction Y, which is the thickness direction of the outer link plate 14. The distal end of the pin 20 has a through-hole 22. A retaining pin 23 that restricts the pin 20 from being separated from the pin insertion holes 21 is inserted into the through-hole 22. The retaining pin 23 has a distal end curved to restrict the retaining pin 23 from being separated from the through-hole 22.

The two outer link plates 14 are rotationally coupled to the two inner link plates 12 by the pin 20 and the bushing 17 in a state in which the two outer link plates 14 are arranged to externally hold the two inner link plates 12 in the width direction Y. In this case, the opposite ends of the pin 20 are fitted (joined) to the pin insertion holes 21 of the two outer link plates 14 of the outer link 15 in a non-rotatable manner in a state in which the intermediate portion other than the opposite ends of the pin 21 is rotationally inserted into the bushing 17, which is installed between the two inner link plates 12 of the inner link 13.

Thus, the opposite ends of the pin 20 respectively extend through the two outer link plates 14. Further, the inner link plates 12 of each inner link 13 and the outer link plates 14 of each outer link 15, which are adjacent to each other in the serial arrangement direction X, are pivotally coupled to each other by the pin 20 and the bushing 17 at the ends in the serial arrangement direction X.

The opposite ends of the bushing 17 slightly protrude toward the outer sides of the two inner link plates 12 in the width direction Y. The bushing 17 includes opposite end surfaces 17b that are in contact with inner surfaces 14a of the two outer link plates 14, respectively. Lubricant G2 is provided between an inner circumferential surface 17c of the bushing 17 and an outer circumferential surface 20a of the pin 20.

A seal member 51 is arranged between an outer surface 12b of each inner link plate 12 and an inner surface 14a of each outer link plate 14 so as to surround the bushing 17. The seal member 51, which has the form of an annular plate, seals the lubricant G2. The inner circumferential surface of the seal member 51 is in contact with the outer circumferential surface 17a of the bushing 17. The opposite sides of the seal member 51 in the width direction Y are in contact with the outer surface 12b of each inner link plate 12 and the inner surface 14a of each outer link plate 14, respectively.

Grease, solid lubricant (for example, powder graphite or powder molybdenum disulfide is compressed into a tubular shape), or the like can be used as the lubricant G1 and the lubricant G2. The lubricant G1 may be the same as or different from the lubricant G2. In the present embodiment, grease is used as the lubricant G1 and the lubricant G2.

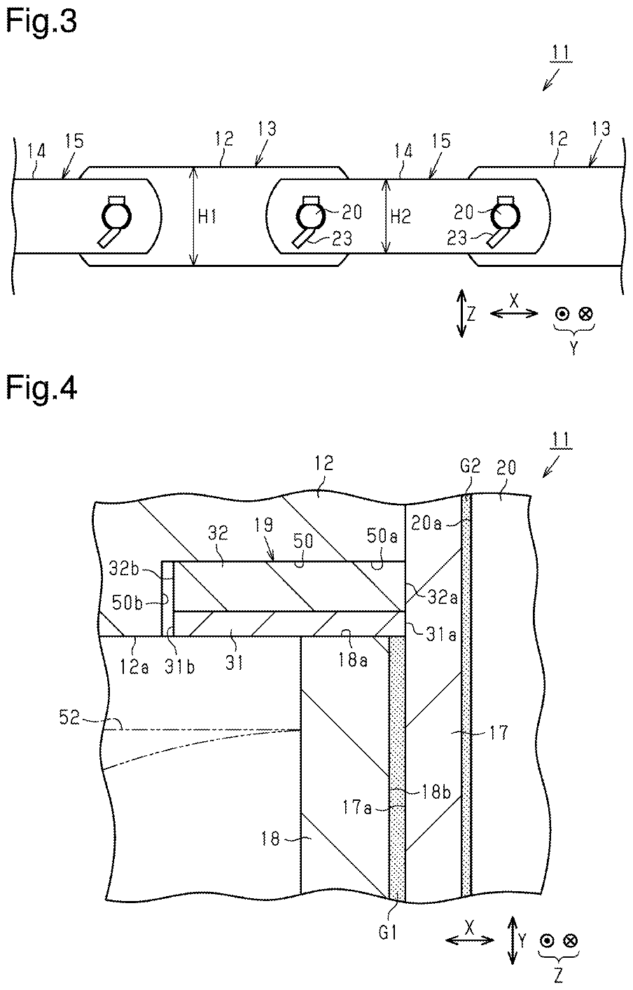

As shown in FIGS. 2 and 3, the thickness of each inner link plate 12 is greater than that of each outer link plate 14. A thickness T of the portion of the inner link plate 12 where the recess 50 is formed is the same as the thickness of the outer link plate 14. A height H1 of the inner link plate 12 is greater than a height H2 of the outer link plate 14. That is, the length of the inner link plate 12 in a height direction Z, which is the direction orthogonal to both the serial arrangement direction X and the width direction Y, is greater than the length of the outer link plate 14 in the height direction Z. While the seal chain 11 is used, the roller 18 located between each pair of the inner link plates 12 is engaged with a sprocket 52.

The structure of the seal 19 will now be described in detail.

As shown in FIG. 4, the seal 19 has a double-layer structure including a first layer 31 and a second layer 32. The first layer 31 is made of a self-lubricating material. The second layer 32 is made of an elastic foam. The first layer 31 is in plane contact with the end surface 18a of the roller 18 in a slidable manner. The second layer 32 is in plane contact with both the surface of the first layer 31 located on the side opposite from the roller 18 and the bottom surface 50a of the recess 50 of the inner link plate 12.

The material configuring the first layer 31 can be a self-lubricating material formed by combining at least two of three materials, namely, synthetic plastic, metal, and sintered material. For example, the first layer 31 may be configured by punching a hole in a metal material and then filling the hole with synthetic plastic. Alternatively, the first layer 31 may be made of metal that has undergone surface treatment (such as coating or gliding) with a higher lubricating performance. In the present embodiment, the first layer 31 is made of self-lubricating synthetic plastic.

The first layer 31 and the second layer 32, which have the form of an annular plate, have the same inner diameter and the same outer diameter and surround the bushing 17. In the present embodiment, the thickness of the first layer 31 is approximately half of that of the second layer 32. The first layer 31 includes an inner circumferential surface 31a, and the second layer 32 includes an inner circumferential surface 32a. The inner circumferential surface 31a and the inner circumferential surface 32a are in contact with the outer circumferential surface 17a of the bushing 17. That is, the inner circumferential surface of the seal 19 is in contact with the outer circumferential surface 17a of the bushing 17.

A slight gap is formed between an outer circumferential surface 31b of the first layer 31 and an inner circumferential surface 50b of the recess 50. A slight gap is formed between an outer circumferential surface 32b of the second layer 32 and the inner circumferential surface 50b of the recess 50. The surface of the first layer 31 in contact with the end surface 18a of the roller 18 is located in substantially the same plane as the inner surface 12a of the inner link plate 12.

The synthetic plastic configuring the first layer 31 can be engineering plastic such as polyamide (nylon), polyether ether ketone (PEEK), and polytetrafluoroethylene (PTFE). In the present embodiment, the synthetic plastic configuring the first layer 31 is polyamide 6, 6 (PA 6, 6; nylon 6, 6), which is excellent in sliding performance and wear resistance.

The elastic foam configuring the second layer 32 can be a closed-cell foam such as nitrile rubber (NBR) and natural rubber (NR). In the present embodiment, the elastic foam configuring the second layer 32 is an oil-resistant nitrile rubber sponge. The elastic force of the second layer 32 presses the inner circumferential surface 32a of the second layer 32 in contact with the outer circumferential surface 17a of the bushing 17. The second layer 32 is in close contact with the surface of the first layer 31 located on the opposite side from the roller 18, the bottom surface 50a of the recess 50, and the outer circumferential surface 17a of the bushing 17 and is slightly compressed.

The operation of the seal 19 when using the seal chain 11 will now be described.

The seal chain 11 is used as, for example, a bucket elevator that carries items in a vertical manner. When the seal chain 11 is used as a bucket elevator, containers that accommodate items such as granular materials are coupled to the seal chain 11. The seal chain 11, to which the containers are coupled, is formed in an endless manner to extend in the vertical direction. The sprockets 52 respectively engage with the curved portions of the upper end and the lower end of the seal chain 11.

When the sprocket 52 located at the upper end of the seal chain 11 is rotated and driven, the seal chain 11 moves in a circular manner. This particularly rotates the roller 18 located at the portion where the roller 18 engages with the sprocket 52. As a result, the lubricant G1 lubricates the section between the roller 18 and the bushing 17. This causes the lubricant G1 to flow through the section between the inner circumferential surface 31a of the first layer 31 of the seal 19 and the outer circumferential surface 17a of the bushing 17 into the section between the inner circumferential surface 32a of the second layer 32 of the seal 19 and the outer circumferential surface 17a of the bushing 17. However, since the inner circumferential surface 32a is in close contact with the outer circumferential surface 17a in a pressed state, the second layer 32 blocks the lubricant G1. Thus, the second layer 32 effectively restricts the lubricant G1 from leaking toward the outside.

Additionally, the second layer 32 is in close plane contact with the first layer 31 and the inner surface 12a of the inner link plate 12. This restricts the entry of foreign matter such as dust from the outside toward the section between the second layer 32 and the first layer 31 and the section between the second layer 32 and the inner surface 12a. This reduces the damage to the seal 19 caused by biting of foreign matter and restricts the entry of foreign matter into the section between the roller 18 and the bushing 17.

When the roller 18 rotates, the roller 18 slides in contact with the self-lubricating first layer 31 of the seal 19. The first layer 31 is in plane contact with the second layer 32 that has been compressed and elastically deformed. Thus, as compared to when the second layer 32 is configured by a typical O-ring (structure described in Patent Document 1), the surface pressure that the first layer 31 receives from the second layer 32 is reduced. Accordingly, the contact pressure of the first layer 31 on the roller 18 is reduced as compared to the typical structure (structure described in Patent Document 1). This and the self-lubrication of the first layer 31 effectively reduce the sliding resistance of the roller 18 while rolling. This restricts the prevention of rotation of the roller 18 by the first layer 31 (seal 19).

When the roller 18 swings in the width direction Y, the elasticity of the second layer 32 causes the seal 19 to follow the movement of the roller 18. This limits a decrease in the sealing performance by the seal 19. That is, when the roller 18 swings toward one side in the width direction Y, the amount of compression elastic deformation of the second layer 32 of the seal 19 located on the side where the roller 18 swings is increased by an amount in which the roller 18 swings, and the amount of compression elastic deformation of the second layer 32 of the seal 19 located on the side opposite from where the roller 18 swings is decreased by an amount in which the roller 18 swings. Thus, even when the roller 18 swings in the width direction Y, rattling of the roller 18 is limited.

The seal 19 is located between the bottom surface 50a of the recess 50 and the end surface 18a of the roller 18 so as to be accommodated in the recess 50 of the inner link plate 12. This limits the contact of the seal 19 with the sprocket 52. In this state, the seal 19 seals the lubricant G1 at or near a location where the lubricant G1 between the bushing 17 and the roller 18 leaks. This prevents the seal 19 (first layer 31) from wearing in a short period of time due to the contact with the sprocket 52. Thus, the seal 19 effectively seals the lubricant G1, which is located between the bushing 17 and the roller 18, for a long period of time.

In this manner, the elasticity of the second layer 32 allows the seal 19 to have sealability and follow the roller 18, and the self-lubrication of the first layer 31 increases the sliding performance of the seal 19 on the roller 18. Additionally, the seal 19 is located in the recess 50, where the contact with the sprocket 52 is limited. Thus, the seal 19 demonstrates relatively low wear due to the contact with the sprocket 52. Accordingly, the seal 19 restricts prevention of the roller 18 from rotating and effectively seals the lubricant G1, which is located between the bushing 17 and the roller 18, for a long period of time.

The first embodiment described above in detail has the following advantages.

(1-1) The seal chain 11 includes the seal 19, which seals the lubricant G1 provided between the bushing 17 and the roller 18. The seal 19 is located between the bottom surface 50a of the recess 50 and the end surface 18a of the roller 18 so as to be accommodated in the recess 50. This restricts the seal 19 from contacting the sprocket 52. Further, the seal 19 seals the lubricant G1 at or near the location where the lubricant G1 provided between the bushing 17 and the roller 18 leaks. Thus, since the seal 19 avoids wearing in a short period of time due to the contact with the sprocket 52, the seal 19 effectively seals the lubricant G1, which is located between the bushing 17 and the roller 18, for a long period of time.

(1-2) In the seal chain 11, the second layer 32 of the seal 19 has an annular shape to surround the bushing 17. The inner circumferential surface 32a of the second layer 32 is in contact with the outer circumferential surface 17a of the bushing 17. Thus, the elasticity of the second layer 32 allows the seal 19 to follow the roller 18 in the width direction Y, which is the axial direction of the bushing 17, and allows the seal 19 to follow the roller 18 in the direction intersecting the axial direction of the bushing (for example, the serial arrangement direction X and the height direction Z). This effectively restricts the lubricant G1, which is located between the bushing 17 and the roller 18, from leaking from the section between the inner circumferential surface 32a of the second layer 32 of the seal 19 and the outer circumferential surface 17a of the bushing 17.

(1-3) In the seal chain 11, the seal 19 includes the self-lubricating first layer 31 and the elastic second layer 32. The first layer 31 is in contact with the end surface 18a of the roller 18. The second layer 32 is in plane contact with both the first layer 31 and the inner link plate 12. Thus, since the first layer 31 is in plane contact with the second layer 32, as compared to when the second layer 32 is configured by a typical O-ring (structure described in Patent Document 1), the surface pressure that the first layer 31 receives from the second layer 32 is reduced. Accordingly, the contact pressure of the first layer 31 on the roller 18 is reduced as compared to the typical structure (structure described in Patent Document 1). This and the self-lubrication of the first layer 31 effectively reduce the sliding resistance between the roller 18 and the first layer 31 while the roller 18 is rotating. Thus, the prevention of rotation of the roller 18 by the first layer 31 is restricted. This seals the lubricant G1, which is located between the bushing 17 and the roller 18, and restricts the prevention of rotation of the roller 18.

(1-4) In the seal chain 11, the second layer 32 is made of a closed-cell foam, in which bubbles are not continuous. Thus, as compared to when the second layer 32 is made of an open-cell foam, in which bubbles are continuous, the seal 19 has a high resilience. Further, this limits the leakage of the lubricant G1, dust, and the like.

(1-5) In the seal chain 11, the thickness of the inner link plate 12 is greater than that of the outer link plate 14, and the thickness T of the portion of the inner link plate 12 where the recess 50 is formed is the same as the thickness of the outer link plate 14. Thus, the strength of the portion of the inner link plate 12 where the recess 50 is formed is the same as that of the outer link plate 14. That is, the strength of the portion of the inner link plate 12 decreased due to the formation of the recess 50 is kept to be almost the same as the strength of the outer link plate 14.

(1-6) In the seal chain 11, the height H1 of the inner link plate 12 (the length in the height direction Z) is greater than the height H2 of the outer link plate 14 (the length in the height direction Z). This limits a decrease in the strength of the inner link plate 12 caused by the formation of the recess 50. That is, the strength of the inner link plate 12 decreased by the formation of the recess 50 is compensated.

(1-7) In the seal chain 11, the second layer 32 of the seal 19 is in close plane contact with the first layer 31 and the inner surface 12a of the inner link plate 12. This restricts the entry of foreign matter such as dust from the outside toward the section between the second layer 32 and the first layer 31 and the section between the second layer 32 and the inner surface 12a. This reduces the damage to the seal 19 caused by biting of foreign matter and restricts the entry of foreign matter into the section between the roller 18 and the bushing 17.

(1-8) In the seal chain 11, the seal 19 has a larger volume than a typical seal (structure described in Patent Document 1). This limits separation of the seal 19 that occurs early in the seal's life due to wearing. Thus, the loss of the lubricant G1 due to the separation of the seal 19 is prevented. Accordingly, the lubrication effect of the lubricant G1 keeps working for a long period of time. This prolongs the wear life of the bushing 17 and the roller 18.

(1-9) In the seal chain 11, the second layer 32 of the seal 19 is not in direct contact with the roller 18. This reduces wearing of the second layer 32 and thus contributes to prolonging of the life of the seal 19.

(1-10) In the seal chain 11, the seal 19 seals the lubricant G1, which is located between the bushing 17 and the roller 18. This prevents the leakage of the lubricant G1 toward the outside for a long period of time and prevents the entry of foreign matter from the outside toward the section between the bushing 17 and the roller 18 for a long period of time. Thus, the seal chain 11 can be used without being refilled with the lubricant G1 (without being oiled).

(1-11) The seal 19 of the seal chain 11 is not a mechanical seal such as an oil seal. This simplifies the structure of the seal 19 and eliminates the need for precise processing.

(1-12) In the seal chain 11, the second layer 32 of the seal 19 is made of nitrile rubber sponge. This reduces the resilient force as compared to when the second layer 32 is made of solid rubber. Thus, the biasing force produced by the second layer 32 toward the roller 18 of the first layer 31 is reduced as compared to when the second layer 32 is made of solid rubber. Accordingly, the contact pressure of the first layer 31 on the roller 18 is reduced, thereby rotating the roller 18 smoothly.

### Second Embodiment

A seal chain according to a second embodiment will now be described with reference to the drawings.

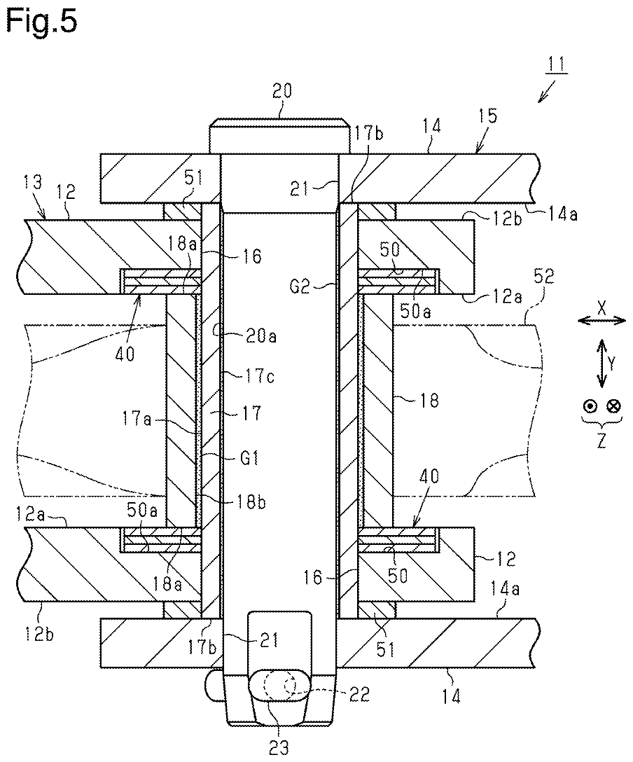

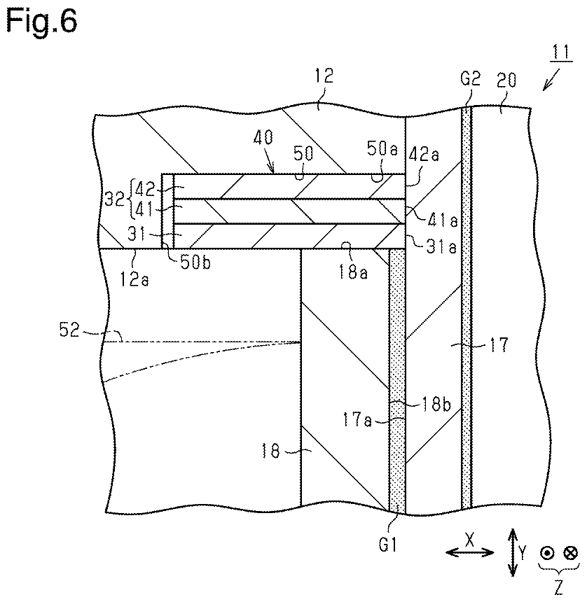

In the second embodiment, the seal 19 of the seal chain 11 of the first embodiment is changed to a seal 40 shown in FIGS. 5 and 6. In other respects, the second embodiment is the same as the first embodiment. Thus, like or same reference numerals are given to those components that are the same as the corresponding components of the first embodiment. Such components will not be described in detail.

As shown in FIGS. 5 and 6, in the seal 40, the second layer 32 of the seal 19 (refer to FIG. 4) of the first embodiment is changed to a double-layer structure. In this structure, a low-resilience layer 41 having a relatively low resilience and a high-resilience layer 42 having a relatively high resilience are laminated. That is, the seal 40 has a triple-layer structure including the first layer 31, the low-resilience layer 41, and the high-resilience layer 42. In the present embodiment, the first layer 31, the low-resilience layer 41, and the high-resilience layer 42 substantially have the same thickness.

The low-resilience layer 41 is made of an elastic foam having the form of an annular plate. The low-resilience layer 41 is in plane contact with both the high-resilience layer 42 and the surface of the first layer 31 located on the side opposite from the roller 18. The elastic foam configuring the low-resilience layer 41 can be a closed-cell foam such as nitrile rubber (NBR) and natural rubber (NR). In the present embodiment, the elastic foam configuring the low-resilience layer 41 is an oil-resistant nitrile rubber sponge.

The low-resilience layer 41 surrounds the bushing 17. The elastic force of the low-resilience layer 41 presses an inner circumferential surface 41a of the low-resilience layer 41 in contact with the outer circumferential surface 17a of the bushing 17. That is, the low-resilience layer 41 is in close contact with the surface of the first layer 31 located on the side opposite from the roller 18, the high-resilience layer 42, and the outer circumferential surface 17a of the bushing 17 and is slightly compressed. That is, the low-resilience layer 41 is located between the first layer 31 and the high-resilience layer 42.

The high-resilience layer 42 is made of an elastic foam having the form of an annular plate. The high-resilience layer 42 is in plane contact with both the bottom surface 50a of the recess 50 of the inner link plate 12 and the surface of the low-resilience layer 41 located on the side opposite from the first layer 31. The elastic foam configuring the high-resilience layer 42 can be a closed-cell foam such as various types of urethane sponge. In the present embodiment, the elastic foam configuring the high-resilience layer 42 is a highly elastic urethane sponge having a relatively high resilience among various types of urethane sponge.

The high-resilience layer 42 surrounds the bushing 17. The elastic force of the high-resilience layer 42 presses an inner circumferential surface 42a of the high-resilience layer 42 in contact with the outer circumferential surface 17a of the bushing 17. That is, the high-resilience layer 42 is in close contact with the surface of the low-resilience layer 41 located on the side opposite from the first layer 31, the bottom surface 50a of the recess 50 of the inner link plate 12, and the outer circumferential surface 17a of the bushing 17 and is slightly compressed.

The operation of the seal 40 when using the seal chain 11 will now be described.

The seal chain 11 is used as, for example, a bucket elevator that carries items in a vertical manner. When the seal chain 11 is used as a bucket elevator, containers that accommodate items such as granular materials are coupled to the seal chain 11. The seal chain 11, to which the containers are coupled, is formed in an endless manner to extend in the vertical direction. The sprockets 52 respectively engage with the curved portions of the upper end and the lower end of the seal chain 11.

When the sprocket 52 located at the upper end of the seal chain 11 is rotated and driven, the seal chain 11 moves in a circular manner. This particularly rotates the roller 18 located at the portion where the roller 18 engages with the sprocket 52. As a result, the lubricant G1 lubricates the section between the roller 18 and the bushing 17.

This causes the lubricant G1 to flow through the section between the inner circumferential surface 31a of the first layer 31 of the seal 40 and the outer circumferential surface 17a of the bushing 17 into the section between the inner circumferential surface 41a of the low-resilience layer 41 of the seal 40 and the outer circumferential surface 17a of the bushing 17. However, since the inner circumferential surface 41a is in close contact with the outer circumferential surface 17a in a pressed state, the low-resilience layer 41 blocks the lubricant G1.

Thus, the low-resilience layer 41 effectively restricts leakage of the lubricant G1 toward the outside from the section between the inner circumferential surface 41a of the low-resilience layer 41 and the outer circumferential surface 17a of the bushing 17, the section between the inner circumferential surface 42a of the high-resilience layer 42 and the outer circumferential surface 17a of the bushing 17, and the section between the high-resilience layer 42 and the bottom surface 50a of the recess 50.

This restricts the high-resilience layer 42 from being exposed to the lubricant G1. The highly elastic urethane sponge configuring the high-resilience layer 42 has a low resistance to the lubricant G1, which includes oil. The nitrile rubber sponge configuring the low-resilience layer 41 has a high resistance (oil resistance) to the lubricant G1, which includes oil. Thus, the low-resilience layer 41 protects the high-resilience layer 42 from the lubricant G1, which includes oil.

When the roller 18 swings in the width direction Y, the elasticity of the low-resilience layer 41 and the high-resilience layer 42 causes the seal 40 to follow the movement of the roller 18. This limits a decrease in the sealing performance of the seal 40. That is, when the roller 18 swings toward one side in the width direction Y, the amount of compression elastic deformation of the low-resilience layer 41 and the high-resilience layer 42 of the seal 40 located on the side where the roller 18 swings is increased by an amount in which the roller 18 swings, and the amount of compression elastic deformation of the low-resilience layer 41 and the high-resilience layer 42 of the seal 40 located on the side opposite from where the roller 18 swings is decreased by an amount in which the roller 18 swings.

The resilience of the highly elastic urethane sponge configuring the high-resilience layer 42 is much higher than that of the nitrile rubber sponge configuring the low-resilience layer 41. That is, the recovery speed of the high-resilience layer 42 from elastic deformation is much higher than the recovery speed of the low-resilience layer 41 from elastic deformation. Thus, the high-resilience layer 42 increases the ability of the seal 40 to follow the roller 18. That is, the high-resilience layer 42 plays an auxiliary role for the low-resilience layer 41 in allowing the seal 40 to follow the roller 18. Thus, even when the roller 18 swings in the width direction Y, the resilient force of the seal 40, especially the resilient force of the high-resilience layer 42, effectively limits rattling of the roller 18.

The second embodiment described above in detail has the following advantages in addition to advantages (1-1) to (1-12).

(2-1) In the seal chain 11, the second layer 32 includes the low-resilience layer 41, which has a relatively low resilience, and the high-resilience layer 42, which has a relatively high resilience. The low-resilience layer 41 is located between the first layer 31 and the high-resilience layer 42. Thus, the resilient force of the high-resilience layer 42 further increases the ability of the seal 40 to follow the roller 18 while protecting the high-resilience layer 42 from the lubricant G1 by the low-resilience layer 41.

(2-2) In the seal chain 11, the seal 40 includes the highly elastic urethane sponge configuring the high-resilience layer 42 and the nitrile rubber sponge configuring the low-resilience layer 41. Thus, the sliding noise generated between the bushing 17 and the roller 18 are physically insulated and absorbed. This contributes to noise reduction in the seal chain 11.

### MODIFICATIONS

The above-described embodiments may be modified as follows.

In the seal chain 11, the height of the inner link plate 12 (the length in the height direction Z) does not necessarily have to be greater than the height of the outer link plate 14 (the length in the height direction Z). That is, the height of the inner link plate 12 may be less than or equal to the height of the outer link plate 14.

In the seal chain 11, the thickness of the inner link plate 12 does not necessarily have to be greater than the thickness of the outer link plate 14. That is, the thickness of the inner link plate 12 may be less than or equal to the thickness of the outer link plate 14.

In the seal chain 11, the thickness T of the portion of the inner link plate 12 where the recess 50 is formed does not necessarily have to be the same as the thickness of the outer link plate 14. That is, the thickness T of the portion of the inner link plate 12 where the recess 50 is formed may be greater than or less than the thickness of the outer link plate 14.

In the seal chain 11, the second layer 32 does not necessarily have to be made of a closed-cell foam. For example, the second layer 32 may be made of an open-cell foam.

In the seal chain 11, the seal 19 does not necessarily have to have an annular shape to surround the bushing 17.

In the seal chain 11, the seal 19 does not necessarily have to include the first layer 31 and the second layer 32.

In the seal chain 11, the inner circumferential surface of the seal 19 does not necessarily have to be in contact with the outer circumferential surface 17a of the bushing 17.

The first layer 31 and the second layer 32 do not necessarily have to have the same inner diameter and the same outer diameter.

The surface of the first layer 31 in contact with the end surface 18a of the roller 18 does not necessarily have to be located in the same plane as the inner surface 12a of the inner link plate 12.

### DESCRIPTION OF REFERENCE CHARACTERS

11) Seal Chain; 12) Inner Link Plate; 14) Outer Link Plate; 17) Bushing; 18) Roller; 18a) End Surface of Roller 18; 19, 40) Seal; 20) Pin; 31) First Layer; 32) Second Layer; 41) Low-Resilience Layer; 42) High-Resilience Layer; 50) Recess; 50a) Bottom Surface of Recess 50; G1, G2) Lubricant; H1) Height of Inner Link Plate 12; H2) Height of Outer Link Plate 14; T) Thickness of Portion of Inner Link Plate 12 where Recess 50 is Formed

1-7. (canceled)

8. A seal chain, comprising:
two inner link plates opposed to and spaced apart from each other;
a tubular bushing, opposite ends of the bushing being respectively joined to the two inner link plates;
a pin rotationally inserted into the bushing;
a tubular roller into which the bushing is inserted, the roller being rotationally supported by the bushing;
two outer link plates arranged to externally hold the two inner link plates, opposite ends of the pin being respectively joined to the two outer link plates;
a recess formed in an inner surface of each of the inner link plates to surround the bushing; and
a seal arranged between a bottom surface of the recess and an end surface of the roller so as to be accommodated in the recess, the seal sealing lubricant provided between the bushing and the roller, wherein
the seal includes
a first layer made of a self-lubricating material, the first layer being in contact with the end surface of the roller, and
a second layer made of an elastic foam, the second layer being in plane contact with both the first layer and the bottom surface of the recess.

9. The seal chain according to claim 8, wherein
the seal has an annular shape to surround the bushing, and
an inner circumferential surface of the seal is in contact with an outer circumferential surface of the bushing.

10. The seal chain according to claim 8, wherein
the second layer includes a low-resilience layer having a relatively low resilience and a high-resilience layer having a relatively high resilience, and
the low-resilience layer is located between the first layer and the high-resilience layer.

11. The seal chain according to claim 8, wherein the second layer is made of a closed-cell foam.

12. The seal chain according to claim 8, wherein
a thickness of the inner link plate is greater than a thickness of the outer link plate, and
a thickness of a portion of the inner link plate where the recess is formed is greater than or equal to the thickness of the outer link plate.

13. The seal chain according to claim 8, wherein a height of the inner link plate is greater than a height of the outer link plate.
